(19) United States
(12) Patent Application Publication
(10) Pub. No.: US 2013/0160718 A1
(43) Pub. Date: Jun. 27, 2013

(54) DUAL LEAD DOG LEASH

(71) Applicants: Kelly Weaver-Pelaez, Baldwin, NY (US); Alexander Pelaez, Baldwin, NY (US)

(72) Inventors: Kelly Weaver-Pelaez, Baldwin, NY (US); Alexander Pelaez, Baldwin, NY (US)

(21) Appl. No.: 13/337,917

(22) Filed: Dec. 27, 2011

(51) Int. Cl. A01K 27/00

(52) U.S. Cl. 119/795

(57) ABSTRACT

The dual lead leash includes two lead leashes, each having a first handle end and an opposite second end, a central control strap having opposite first and second ends, a central connector for the separate attachment of the second ends of the two lead leashes and central control strap, and a releasable connector attached to the first end of the central control strap for attachment to a dog's collar.

### BACKGROUND OF THE INVENTION

1. Field of the Invention

This invention relates generally to animal leashes. More particularly, the invention relates to a dual lead dog leash.

2. Brief Description of the Prior Art

Dog leashes have conventionally been designed with a single strap, having a handle grip on one end of the strap for a user to restrict the movement of an animal, and either a collar, or a clip for attachment to a collar or harness at its other end. More recently, a diverse variety of leashes have been developed which are configured for specific situations. For example, a leash may be provided with multiple straps and a single handle, such that more than one dog can be walked by a single individual. Other leashes are designed to have a single strap with two alternatively-employed, spaced-apart handles with one disposed closer to the dog's collar to enable close control over the dog to ensure the safety of the public in high traffic situations, or so that an individual may train a dog.

Currently, no dog leash presently exists which is tailored to the specific situation whereby two users can simultaneously and safely control a dog via two independent leads so that a dog-walking novice can be taught to walk and control a dog, as the novice holds one lead, while a more experienced user holds the other lead, concurrently ensuring the safety of the dog and the public.

U.S. Pat. No. 5,649,504 to Culp discloses a leash system comprising a distance lead and a close control lead, each with a handle and a clasp and which are suitable for independent use. Thus, two complete leashes are provided that allow for more, or less freedom of a dog based on the lead selected, and each lead is independently usable.

U.S. Pat. No. 5,363,810 to Kraus discloses an animal control tether comprising an elongated strap body, having a first handle provided at one end of the body, and a second handle provided at the opposite end, generally adjacent to the clasping device.

However, Culp and Kraus suffer from several deficiencies for any multi-user type scenarios. While Culp discloses a two lead design, it does not teach use by multiple handlers. Referring to FIG. 1, careful examination reveals that the connection point or D-ring 14, where the distance lead 1 is connected to the close control lead 2, is fixed on close control lead 2. Therefore, distance lead 1 and close control lead 2 cannot operate independently of one another, and if two handlers were walking a dog with a leash according to Culp, their leads 1 and 2 may become entangled, or wrapped around each other during the course of teaching a handler how to walk a dog. Furthermore, if the D-ring 14, as demonstrated in FIG. 1, is on the left side of the dog, then lead 1, and, in turn its handler, must always be on the left side, or entanglement would occur and add potential strain on the dog's collar. Additionally, since the distance lead 1 is attached to the close control lead 2, the effect of corrections by either lead 1 or 2 could be negated by the other, and the fixed nature of connection point 14 on close control lead 2 limits the range of distance between handlers from an angular perspective.

Kraus suffers from deficiencies similar to those found in Culp. As shown in FIG. 2, the connection point, where the second handle 26 is attached to the leash body 22, is a secure stitched attachment and, therefore, the handles 24 and 26 of the leash 20 cannot operate independently of one another. If two handlers were walking a dog, the leash 20 may become entangled, or wrapped around second handle 26 during the course of teaching a handler how to walk a dog. In addition, because the second handle 26 is stitched to the leash body 22, the effect of corrections by either handle 24 or 26 could be negated by the other, and the fixed nature of the connection point limits the range of distance between handlers from an angular perspective.

Moreover, due to the aforementioned deficiencies, and the extremely short lengths of their short control leads, namely, 10-20 inches and 6-24 inches, respectively, Culp and Kraus are directed to a multi-lead leash only for the close control of a dog for use in high traffic situations, and likely by a single user. Thus, neither Culp nor Kraus teaches a leash having two independent leads so that a dog-walking novice can be taught to walk and control a dog, as the novice holds one lead, while a more experienced user holds the other lead, concurrently ensuring the safety of the dog and the public.

It is, therefore, advantageous to provide dual leads to permit two handlers to work with a dog, such that the less experienced canine handler has the normal feel of walking the dog. Moreover, it is desirable to provide a dual lead leash which allows for the main handler to maintain a further distance from the animal and exercise minimal or maximum control as needed when training a new handler, resulting in increased effectiveness of training and confidence between the novice handler and the dog. It is also desirable to provide a central control strap, entirely separate from the two control leads, which is connected to the dog, and thus any corrections by either handler via the control leads are transferred directly to the central control strap, which the dog perceives as a single leash. Furthermore, it is desirable to have a leash where the energy of simultaneous corrections by handlers are transferred to a central control strap, thereby maintaining a singular effect from the perception of the dog.

The prior art discloses many different types of dog leashes. However, so far as is known, none of the prior art devices resolve all of these problems in a simple, effective and yet highly advantageous manner as does the present invention disclosed herein.

### SUMMARY OF THE INVENTION

It is therefore an object of the invention to provide a novel dog leash. It is a further object of the invention to provide a dual lead training leash for use in the control of a dog, which is releasably attachable to a dog's collar

It is another object of the invention to provide a dog leash with separate leads which are independent of one another.

It is yet another object of the invention to provide a dog leash with a central control strap, separate from the two separate leads, releasably attachable to the collar of a dog.

It is a further object of the invention to provide a dual lead training leash for two handlers to work with a canine, such that a less experienced canine handler has the normal feel of walking the dog, and the safety of the public and dog are ensured.

It is yet another object to provide a dual lead leash for two handles that will not become tangled during the walking of a dog and that does not strain the neck of the dog.

Certain of the foregoing and related objects are readily attained according to the present invention by the provision of a dual lead training leash for use in the control of a dog which is releasably attachable to a dog's collar, comprising a first lead strap, having a first end having a handle and an opposite second end; a separate second lead strap, having a first end having a handle and an opposite second end; a central control strap, having a first end and an opposite second end, and means for releasably attaching said first end to a dog's collar; a central connector; and means for separately attaching said second ends of said first and second lead straps, and said second end of said central control strap to said central connector.

In a first embodiment, said first lead strap and said second lead strap have lengths which are different, while in another embodiment, said first lead strap and said second lead strap have lengths which are equal.

In one embodiment, said central connector is a ring, while in another embodiment said ring is generally circular-shaped, and in yet another embodiment, said ring is generally triangularly-shaped. In a preferred embodiment, said central connector is a pair of connector rings; and means for connecting said connector rings, which permits said connector rings to swivel independently of one another. It is desirable for each of said connector rings to be generally D-shaped.

Preferably, said handles of said first and second straps are each in the form of a loop formed from said first and second straps. In a preferred embodiment, said means for separately attaching said second ends of said first and second lead straps, and said second end of said central control strap to said central connector, are closed loops formed around said central connector.

In another embodiment, said means for attaching said second end of at least one of said lead straps to said central connector is a releasable fastener. It is desirable that said releasable fastener is a swivel eye bolt snap having a first end having a ring connected to said second end of one of said lead straps and an opposite second end having a bolt snap with a spring-loaded thumb press and moveable latch which is releasably connectable to said central connector; and means for connecting said ring and said bolt snap which permits them to swivel independently of one another. It is also desirable that said means for releasably attaching said first end of said central control strap to a dog's collar is a swivel eye bolt snap having a first end having a ring connected to said second end of one of said lead straps and an opposite second end having a bolt snap with a spring-loaded thumb press and moveable latch which is releasably connectable to said central connector; and means for connecting said ring and said bolt snap which permits them to swivel independently of one another.

In a preferred embodiment, said first and second lead straps have a length in a range between forty-eight inches to ninety-six inches; and said first and second lead straps have a width in a range between one half inch to one and a half inches. It is also preferable that said central control strap has a length in a range between three inches to eighteen inches; and said central control strap has a width in a range between one half inch to one and a half inches.

It is desirable that said first and second lead straps, and said central control strap are composed of a material selected from the group consisting of nylon, rope, metal, and leather. Preferably, said central connector has a length in a range between one inch to four inches, said swivel eye bolt snap has a length in a range between one quarter inch to five inches, and said handles have a length in a range between five inches to ten inches.

Provided in another embodiment are further means of releasably attaching said first and second lead straps to each other to form a singular lead strap.

### BRIEF DESCRIPTION OF THE DRAWINGS

Other objects and features of the present invention will become apparent from the detailed description considered in connection with the accompanying drawings, which disclose several embodiments of the invention. It is to be understood that the drawings are to be used for the purpose of illustration only and not as a definition of the limits of the invention.

FIG. 1 is a perspective view of a first type of prior art dog leash;

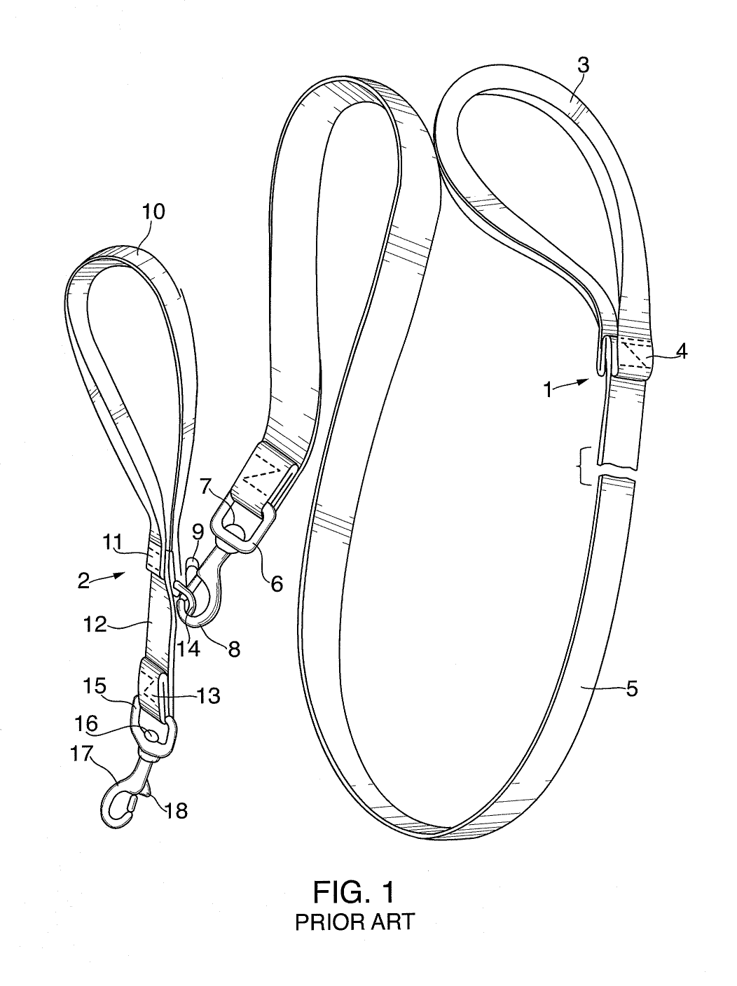

FIG. 2 is a perspective view of a second type of prior art dog leash;

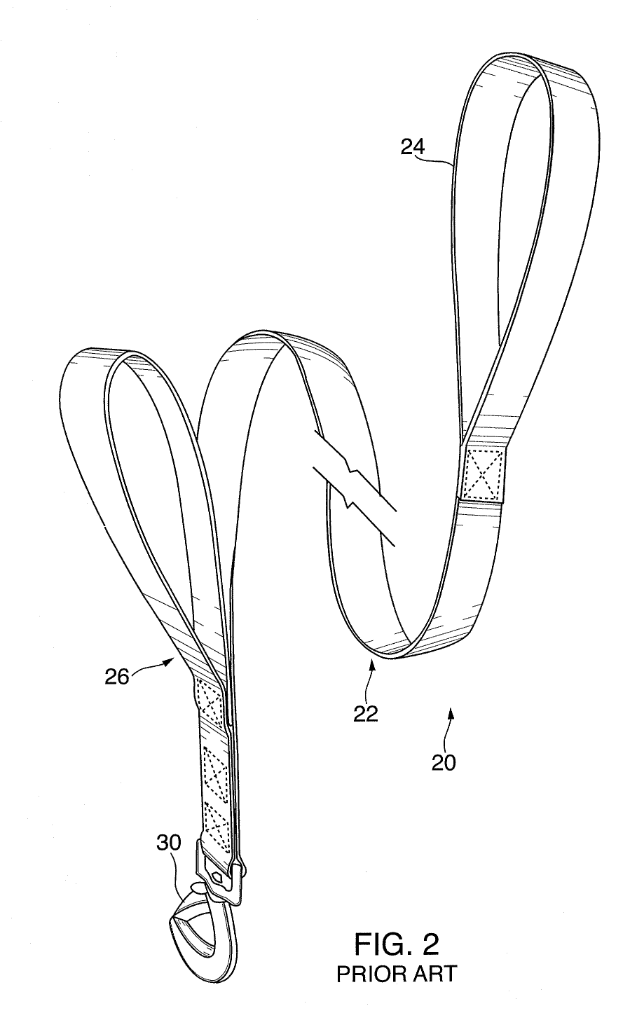

FIG. 3 is a perspective view of a first embodiment of the dual lead leash of the present invention having a double swivel D-ring as the central connector therebetween, and with one lead having a different length than the other lead;

FIG. 4 is a perspective view of the dual lead leash shown in FIG. 3 in use connected to a dog's collar and an adult and child each holding one of the leads of the leash;

FIG. 5 is a perspective view of a second embodiment of the present invention with the leads having equal lengths and with one of the leads having a releasable attachment to the central connector;

FIG. 6 is a perspective view of a third embodiment of the present invention, but showing a circular-shaped ring as the central connector; and

FIG. 7 is a perspective view of a fourth embodiment showing a triangle-shaped ring as the central connector.

### DETAILED DESCRIPTION OF THE PREFERRED EMBODIMENTS

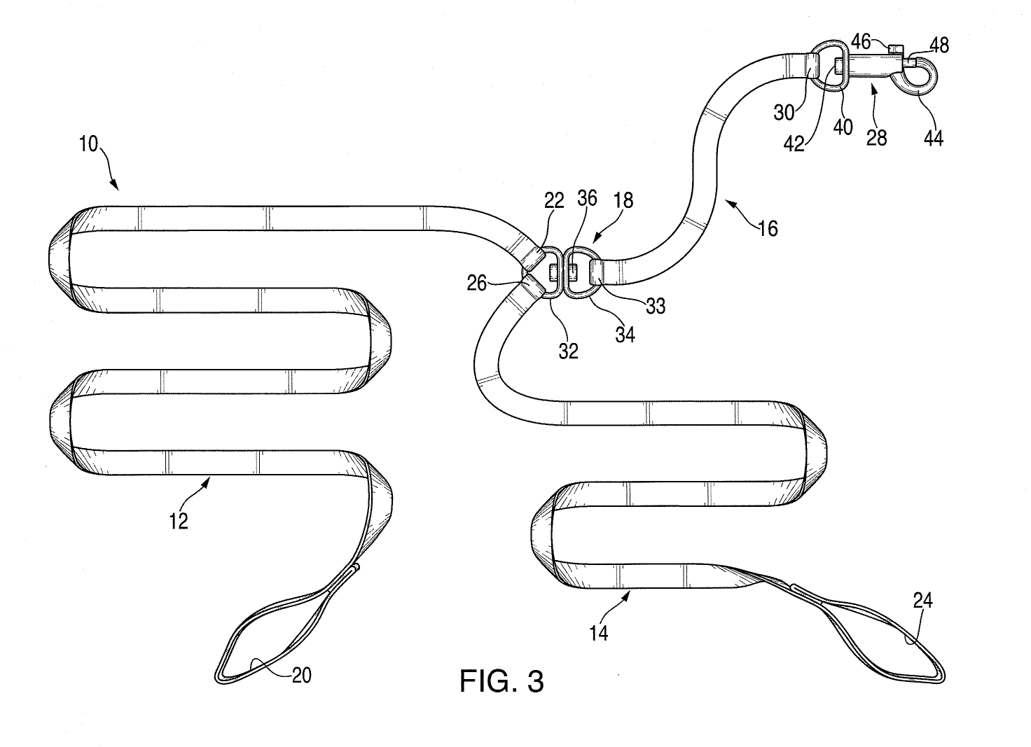

Referring to FIG. 3, therein illustrated is a dual lead dog leash of the present invention, generally designated by numeral 10, which is releasably attachable to a dog's collar or harness (not shown). Dual lead dog leash 10 comprises a first lead leash 12, a separate second lead leash 14, a central control strap 16, and a central connector 18 which is attachable to lead leashes 12 and 14 and central control strap 16. The dual lead leash 10 also includes a releasable connector 28 located at the distal end of central control strap 16 for attachment to a dog's collar (not shown).

More particularly, as shown in FIG. 3, the first embodiment of the dual lead dog leash according to the present invention includes two separate lead leashes 12 and 14, each of which each have a handle 20 and 24, respectively, on the first ends thereof which are to be grasped by the users. Preferably, the handles 20 and 24 are formed by looping the ends of lead 12 and 14 upon itself, and securing it unto itself via reinforced stitching. However, other handle configurations for lead leashes 12 and 14 are possible. Lead leashes 12 and 14 also include opposite second ends 22 and 26, respectively. As also seen in FIG. 3, lead leash 12 preferably has a length which is greater than the length of lead leash 14; however, it can be appreciated that the leads can have lengths which are equal.

Furthermore, the dual lead leash 10 also includes a central connector 18. The lead leashes 12 and 14 and central control strap 16 are all separately connectable to the central connector 18. As seen in FIG. 3, the central connector comprises two swivably-connected rings 32 and 34. Central connector 18 preferably comprises first and second D-shaped rings 32 and 34 respectively, each having an aperture (not shown) extending through its flat side so that the D-shaped rings 32 and 34 can be swivably held together via a double-headed bolt 36, sized and dimensioned to pass through the apertures (not shown), and in turn, secure D-rings 32,34 together back-to-back, preventing their disengagement, yet enabling them to swivel independently of one another around bolt 36.

Lead straps 12 and 14 are separately connected to the first D-shaped ring 32 of central connector 18 via their second ends 22 and 26, respectively. In particular, the second end 22 of lead leash 12 includes a loop on the end thereof, which is formed by looping lead 12 upon itself and around D-shaped ring 32 of central connector 18 and secured to itself via reinforced stitching. Furthermore, the second end 26 of lead leash 14 includes a loop on the end thereof, which is formed by looping lead 14 upon itself and around D-shaped ring 32 of central connector 18 and secured to itself via reinforced stitching. However, other means of securement of the leads 12 and 14 to central connector 18 are possible.

Additionally, central control strap 16 has opposite first and second ends 30 and 33, respectively. Central control strap 16 is connected to central connector 18, separate from lead leashes 12 and 14. Particularly, central control strap 16 is connected to the second D-shaped ring 34 of central connector 18 via its second end 33. The first end 30 of central control strap 16 is connected to a releasable connector 28. In particular, first end 30 is connected to D-ring 40 of releasable connector 28. First and second ends 30, 33 of central control strap 16 include loops on the ends thereof, which are formed by looping each end 30, 33 upon itself, and around D-ring 40 of releasable connector 28 and second D-shaped ring 34, respectively, and secured to themselves via reinforced stitching. However, other means of securement of central control strap 16 to central connector 18 and releasable connector 28 are possible.

Releasable connector 28, which is attached to the first end 30 of central control strap 16, is releasably attachable to a dog's collar or harness (not shown). Preferably, releasable connector 28 is a swivel eye bolt snap, comprising a first end having a D-shaped ring 40 with an aperture (not shown) extending through its flat side, and a second end having a conventional bolt snap 44 with a spring-loaded thumb press 46 and a moveable latch 48 movable between an open and closed position. D-shaped ring 40 and bolt snap 44 are held together via a single-headed bolt 42 sized and dimensioned to pass through the aperture (not shown) of D-shaped ring 40 and into bolt snap 44 to prevent their disengagement while enabling the bolt snap 44 to swivel independently of D-shaped ring 40 around bolt 42. Thumb press 46 is capable of opening moveable eye 48 of bolt snap 44 when pressed downwardly, and snapping moveable eye 48 closed when released, for the securement of dual lead dog leash 10 to a dog's collar or harness (not shown). Once dual lead leash 10 is secured to a dog's collar or harness (not shown) it can be used to teach an inexperienced handler to walk a dog.

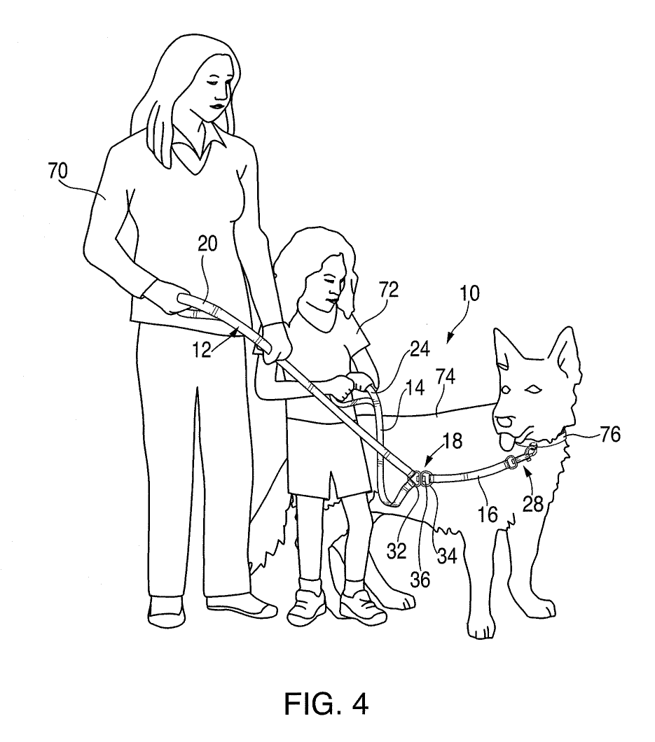

Turning now to FIG. 4, therein illustrated is the first embodiment of the present invention in use, showing two handlers 70 and 72 controlling a dog 74 via dual lead leash 10. In use, each handler 70 and 72 grasps a separate lead 12 and 14 via their respective handles 20 and 24. The dual leads 12 and 14 permits two handlers 70 and 72 to work with a dog 74, such that the less experienced handler, here, a child 72 has the normal feel of walking the dog 74 while the experienced handler, here an adult 70 maintains a greater distance from the dog 74, serving as back-up and exercises minimal or maximum control, as needed when training child 72. The dual lead leash 10 of the present invention increases the effectiveness of training and confidence between the child handler 72 and the dog 74 while ensuring the safety of the public (not shown), since adult handler 70 always maintains control over the dog 74.

As it can be appreciated from FIG. 4, because dual lead leash 10 comprises separate leads 12 and 14, and central control strap 16, which are all separately attached to the central connector 18, the handlers 70 and 72 can both easily be on either side of the dog 74 (not shown) and are able to move freely in a relatively wide range, preferably, from directly behind the dog, so that the leads 12 and 14 are generally parallel or at an acute angle to each other, to far apart from one another, so that the leads 12 and 14 form an obtuse angle of up to slightly less than 180 degrees relative to one another behind the dog 74. The double swivel D-ring 32, 34, 36 construction of central connector 18 ensures that leads 12 and 14 will not become entangled during the walking of dog 74, if handlers 70 and 72 cross paths or dog 74 changes direction. Furthermore, because central control strap 16 is entirely separate from leads 12 and 14, and, in turn, is connected to the dog 74, any corrections by either handler 70 or 72, via the control leads 12 and 14, are transferred directly to the central control strap 16, which the dog 74 perceives as a single leash. In addition, central control strap 16 limits the weight placed directly on the neck of dog 74, diffusing agitation or strain on the dog 74.

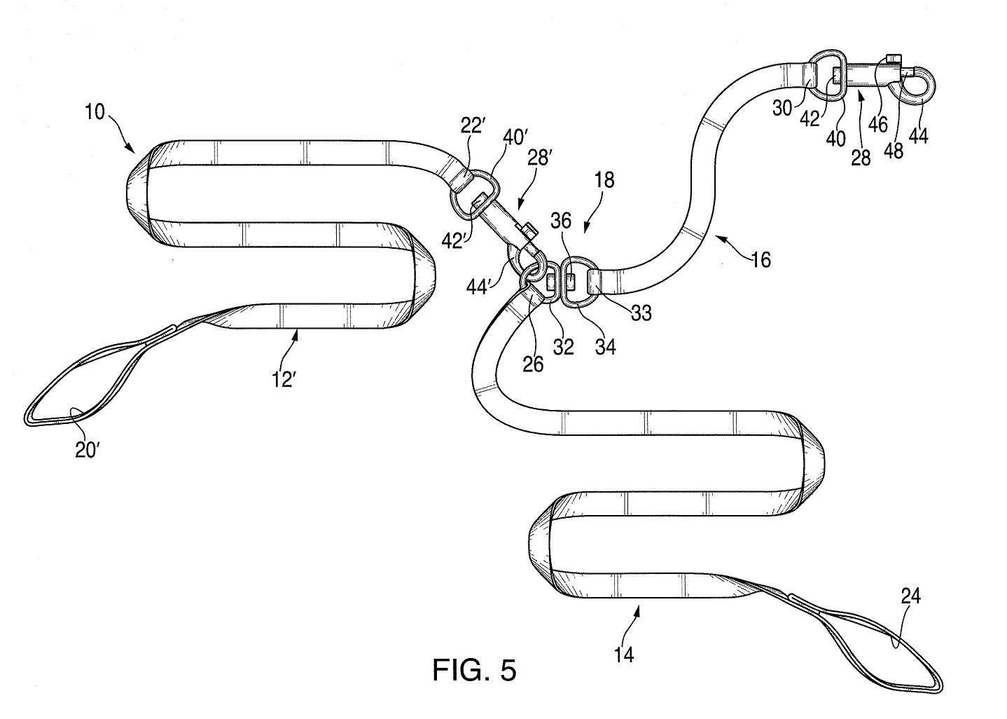

Referring to FIG. 5, therein illustrated is an alternate second embodiment of the dual lead dog leash 10 of the present invention. As seen in FIG. 5, second lead leash 14, central control strap 16, central connector 18, and releasable connector 28 are constructed identically, and operate in the exact same manner as in the first embodiment illustrated in FIG. 3 and described above. However, as shown in FIG. 5, first lead leash 12′ is shorter than lead leash 12 of the first embodiment, and preferably, of an equal length to lead leash 14.

In addition, as further shown in FIG. 5, lead leash 12′ is releasably connectable to central connector 18. Particularly, the second closed stitched end 22′ of lead leash 12′ is connected to a releasable connector 28′, which is identical to the releasable connector 28 of the first embodiment. More particularly, lead leash 12′ is connected to D-ring 40′ of releasable connector 28′ via second closed stitched end 22′. As can be appreciated, bolt snap 44′ of releasable connector 28′ can, in turn, be releasably attached to the first D-shaped ring 32 of central connector 18. Therefore, the dual lead leash 10 is optionally convertible to a single lead leash by a handler, as lead 12′ can be removed from dual lead leash 10. Lead 14 could, alternatively, be releasably connectable to central connector 18 or both leads 12 and 14 can be releasably connectable to central connector 18.

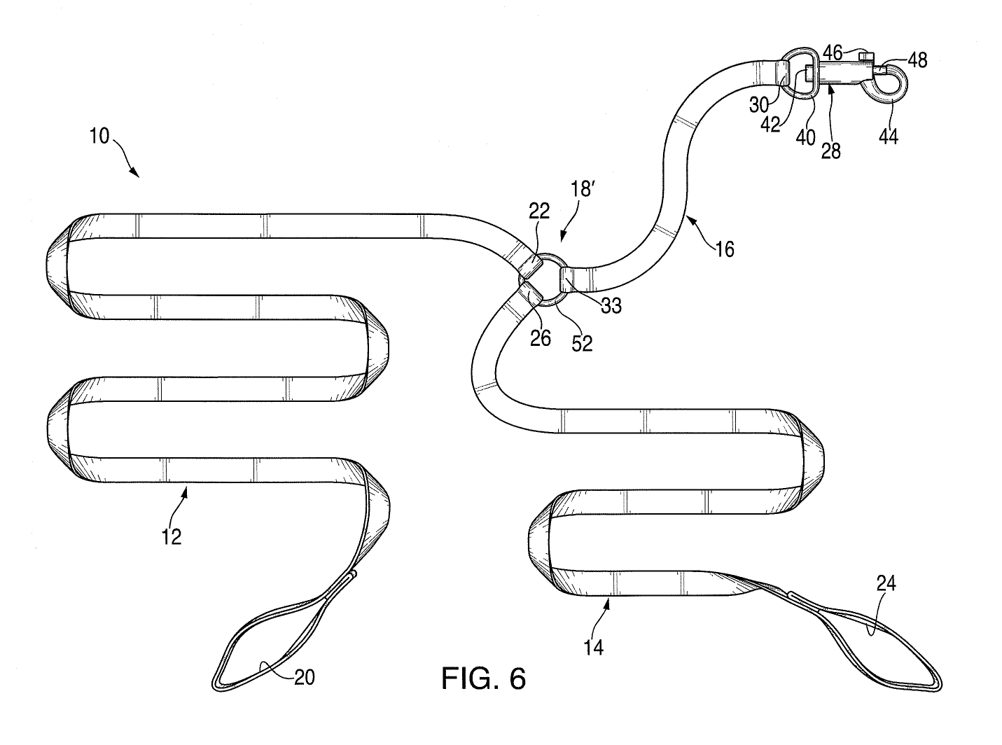

Referring to FIG. 6, therein illustrated is an alternate third embodiment of the dual lead dog leash 10 of the present invention. As seen in FIG. 6, first lead leash 12, second lead leash 14, central control strap 16, and releasable connector 28 are constructed identically, and operate in the exact same manner, as in the first embodiment illustrated in FIG. 3 and described above. However, as shown in FIG. 6 central connector 18′ comprises a single generally circular-shaped ring 52. Lead leashes 12 and 14 are separately connected to one side of circular-shaped ring 52 of central connector 18′ via closed stitched ends 22, 26, respectively. Central control strap 16 is separately connected to the opposite side of circular-shaped ring 52, via second closed stitched end 33.

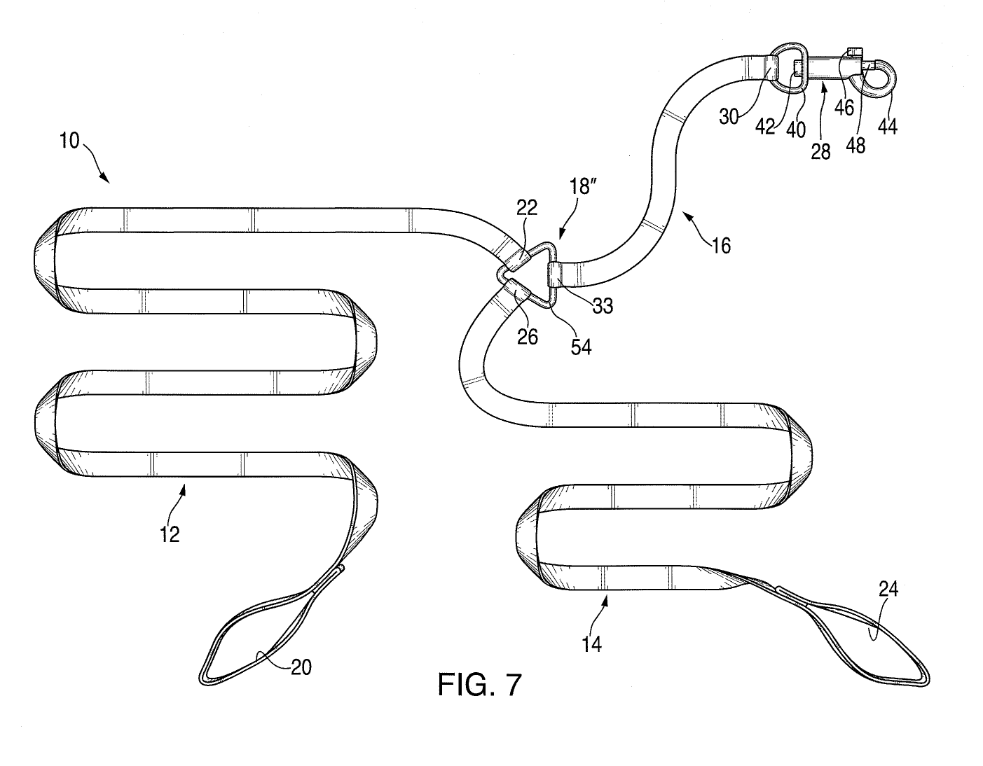

Referring to FIG. 7, therein illustrated is an alternate fourth embodiment of the dual lead dog leash 10 of the present invention. As seen in FIG. 7, first lead leash 12, second lead leash 14, central control strap 16, and releasable connector 28 are constructed identically, and operate in the exact same manner, as in the first embodiment illustrated in FIG. 3 and described above. However as shown in FIG. 7, central connector 18″ comprises a generally triangular-shaped ring 54. Lead straps 12 and 14 are separately connected to separate first and second sides of the triangular-shaped ring 54 of central connector 18″ via closed stitched ends 22 and 26, respectively. Central control strap 16 is separately connected to the third side of the triangular-shaped ring 54, via second closed stitched end 33.

In practice, lead leashes 12 and 14 have a preferable length in a range between forty-eight inches to ninety-six inches, and a preferable width in a range between one half inch to one and a half inches, however other suitable dimensions can be utilized. Central control strap 16 has a preferable length in a range between three inches to eighteen inches, and a preferable width in a range between one half inch to one and a half inches, however other suitable dimensions can be utilized. Preferably, lead leashes 12 and 14 and central control strap 16 are composed of either nylon, rope, metal, leather, or a combination thereof, however other suitable materials can be utilized. Central connector 18 has a preferable length in a range between one inch to four inches, however other suitable dimensions can be utilized. Additionally, central connector 18 is preferably constructed from stainless steel, however, other suitable materials, including, but not limited to plastic, may be utilized. Releasable connector 28, or swivel eye bolt snap, has a preferable length in a range between one quarter inch to five inches, however other suitable dimensions can be utilized. Preferably, releasable connector 28 is constructed from stainless steel, however other suitable materials, including, but not limited to plastic, may be utilized. Handles 20 and 24 have a preferable length in a range between five inches to ten inches, however other suitable dimensions can be utilized.

In addition, handles 20 and 24 can optionally be provided with clips (not shown), or snaps (not shown) so that their size can be adjusted to meet the size of a handler's hand. The handles can also be constructed from plastic, and ergonomically designed for the comfort of the handlers. Lead leashes 12 and 14 can optionally be provided with a releasable coupling mechanism, such as a clip (not shown), snaps (not shown), or VELCRO (not shown), such that the dual lead leash 10 can be optionally, yet releasably, be converted to a single lead leash. Lead leashes 12 and 14 of leash 10 can also be constructed to be extendable and retractable to give the dog more or less freedom as desired. Moreover, central connector 18 can optionally be enclosed by a cover (not shown), constructed preferably of leather, although other suitable materials can be utilized.

Thus, while particular embodiments of the invention have been described, it is not intended that the invention be limited thereto, as it is intended that the invention be as broad in scope as the prior art will allow and that the specification be read likewise. It will therefore be appreciated by those skilled in the art that other modifications could be made thereto without departing from the spirit and scope of the invention.

We claim:

1. A dual lead training leash for use in the control of a dog which is releasably attachable to a dog's collar, comprising:
a first lead strap, having a first end having a handle and an opposite second end;
a separate second lead strap, having a first end having a handle and an opposite second end;
a central control strap, having a first end and an opposite second end, and means for releasably attaching said first end to a dog's collar;
a central connector; and
means for separately attaching said second ends of said first and second lead straps, and said second end of said central control strap to said central connector.

2. The dual lead training leash according to claim 1, wherein:
said first lead strap and said second lead strap have lengths which are different.

3. The dual lead training leash according to claim 1, wherein:
said first lead strap and said second lead strap have lengths which are equal.

4. The dual lead training leash according to claim 1, wherein:
said central connector is a ring.

5. The dual lead training leash according to claim 4, wherein:
said ring is generally circular-shaped.

6. The dual lead training leash according to claim 4, wherein:
said ring is generally triangularly-shaped.

7. The dual lead training leash according to claim 1, wherein:
said central connector is a pair of connector rings; and
means for connecting said connector rings, which permits said connector rings to swivel independently of one another.

8. The dual lead training leash according to claim 7, wherein:
each of said connector rings are generally D-shaped.

9. The dual lead training leash according to claim 1, wherein:
said handles of said first and second straps are each in the form of a loop formed from said first and second straps.

10. The dual lead training leash according to claim 1, wherein:
said means for separately attaching said second ends of said first and second lead straps, and said second end of said central control strap to said central connector are closed loops formed around said central connector.

11. The dual lead training leash according to claim 1, wherein:
said means for attaching said second end of at least one of said lead straps to said central connector is a releasable fastener.

12. The dual lead training leash according to claim 11, wherein:
said releasable fastener is a swivel eye bolt snap having a first end having a ring connected to said second end of one of said lead straps and an opposite second end having a bolt snap with a spring-loaded thumb press and moveable latch which is releasably connectable to said central connector; and
means for connecting said ring and said bolt snap which permits them to swivel independently of one another.

13. The dual lead training leash according to claim 1, wherein:
said means for releasably attaching said first end of said central control strap to a dog's collar is a swivel eye bolt snap having a first end having a ring connected to said second end of one of said lead straps and an opposite second end having a bolt snap with a spring-loaded thumb press and moveable latch which releasably connectable to said central connector; and
means for connecting said ring and said bolt snap which permits them to swivel independently of one another.

14. The dual lead training leash according to claim 1, wherein:
said first and second lead straps have a length in a range between forty-eight inches to ninety-six inches; and
said first and second lead straps have a width in a range between one half inch to one and a half inches.

15. The dual lead training leash according to claim 1, wherein:
said central control strap has a length in a range between three inches to eighteen inches; and
said central control strap has a width in a range between one half inch to one and a half inches.

16. The dual lead training leash according to claim 1, wherein:
said first and second lead straps, and said central control strap are composed of a material selected from the group consisting of nylon, rope, metal, and leather.

17. The dual lead training leash according to claim 1, wherein:
said central connector has a length in a range between one inch to four inches.

18. The dual lead training leash according to claim 1, wherein:
said swivel eye bolt snap has a length in a range between one quarter inch to five inches.

19. The dual lead training leash according to claim 1, wherein:
said handles have a length in a range between five inches to ten inches.

20. The dual lead training leash according to claim 1, further comprising:
means of releasably attaching said first and second lead straps to each other to form a singular lead strap.
